(19) United States
(12) Patent Application Publication
(10) Pub. No.: US 2016/0319799 A1
(43) Pub. Date: Nov. 3, 2016

(54) HYDRAULIC RADIAL PISTON DEVICES

(71) Applicant: EATON CORPORATION, Cleveland, OH (US)

(72) Inventors: Jeffrey David SKINNER, JR., Madison, MS (US); Kendrick Michael GIBSON, Chattanooga, TN (US); Mark Alan LONG, Pearl, MS (US); William Landrum FAIRCHILDS, Morton, MS (US)

(73) Assignee: EATON CORPORATION, Cleveland, OH (US)

(21) Appl. No.: 15/109,146

(22) PCT Filed: Dec. 30, 2014
(86) PCT No.: PCT/US14/72766

§ 371 Date: Jun. 30, 2016

Related U.S. Application Data
(60) Provisional application No. 61/922,400, filed on Dec. 31, 2013.

(51) Int. Cl. F03C 1/047; F04B 1/107

(52) U.S. Cl. CPC F03C 1/0476; F04B 1/1077

(57) ABSTRACT

A radial piston device (100) includes: a housing (102), a pintle (110), a rotor (130), a plurality of pistons (150) and a drive shaft (190). The radial piston device also includes a mechanism for minimizing deflection or curvature of the pintle shaft (112), which may be caused by a resulting pressure applied to the pintle shaft. In one example, the mechanism may be implemented by at least partially supporting the rotor by the housing with a bearing while the rotor is also supported by the pintle shaft with another bearing.

### CROSS-REFERENCE TO RELATED APPLICATIONS

This application is being filed on Dec. 30, 2014, as a PCT International Patent application and claims priority to U.S. Patent Application Ser. No. 61/922,400 filed on Dec. 31, 2013, the disclosure of which is incorporated herein by reference in its entirety.

### BACKGROUND

Radial piston devices (either pumps or motors) are often used in aerospace hydraulic applications and are characterized by a rotor rotatably engaged with a pintle. The rotor has a number of radially oriented cylinders disposed around the rotor and supports a number of pistons in the cylinders. A head of each piston contacts an outer thrust ring that is not axially aligned with the rotor. A stroke of each piston is determined by the eccentricity of the thrust ring with respect to the rotor. When the device is in a pump configuration, the rotor can be rotated by operation of a drive shaft associated with the rotor. The rotating rotor draws hydraulic fluid into the pintle, and forces the fluid outward into a first set of the cylinders so that the pistons are displaced outwardly within the first set of the cylinders. As the rotor further rotates around the pintle, the first set of the cylinders becomes in fluidic communication with the outlet of the device and the thrust ring pushes back the pistons inwardly within the first set of the cylinders. As a result, the fluid drawn into the first set of the cylinders is displaced into the outlet of the device through the pintle.

The fluid drawn into the cylinders exerts different degrees of pressure onto the pintle depending on the stroke of each piston. For example, the fluid entering the cylinders has a lower pressure on one side of the pintle than the fluid discharging from the cylinder has on the opposite side of the pintle. This resulting difference in pressure that the fluid exerts onto the pintle causes the pintle to deflect along the pintle axis. The curvature of the pintle results in misalignment with the rotor. This misalignment prevents the rotor from rotating about the pintle as designed. The problem of the pintle deflection is exacerbated when the radial piston device is used for high pressure flows or when the pintle is designed to have a small diameter to minimize the overall size of the device.

### SUMMARY

The present disclosure relates generally to a radial piston device. In one possible configuration and by non-limiting example, the radial piston device includes a housing, a pintle, a rotor, a plurality of pistons, and a drive shaft.

In one example, the housing has a hydraulic fluid inlet and a hydraulic fluid outlet. The pintle is attached to the housing and has a pintle shaft. The rotor is rotatably mounted on the pintle shaft and has a plurality of cylinders. The plurality of pistons is displaceable in the plurality of cylinders, respectively. The drive shaft is coupled to the rotor and rotatably supported within the housing. The pintle shaft defines a fluid communication between the hydraulic fluid inlet and the plurality of cylinders and a fluid communication between the plurality of cylinders and the hydraulic fluid outlet.

In another example, the housing includes a hydraulic fluid inlet and a hydraulic fluid outlet. The pintle may be attached to the housing and includes a pintle shaft which defines a pintle inlet and a pintle outlet. The pintle inlet is configured to be in fluid communication with the hydraulic fluid inlet, and the pintle outlet is configured to be in fluid communication with the hydraulic fluid outlet. The rotor may be mounted on the pintle shaft so as to rotate about the pintle shaft relative to the pintle. The rotor may define multiple cylinders that are radially oriented around the rotor. The rotor may also define multiple rotor fluid ports below the cylinders, respectively. The rotor fluid ports are in fluid communication with the corresponding cylinders. The pistons are displaceably accommodated within the cylinders, respectively. The radial piston device may further include a thrust ring. The thrust ring may be disposed about the rotor while being in contact with each of the pistons. A thrust ring axis of rotation is radially offset from a rotor axis of rotation. Accordingly, as the rotor rotates about the rotor axis of rotation, the pistons reciprocates radially within the cylinder, and the rotor fluid ports are alternatively in fluid communication with either the pintle inlet or the pintle outlet depending on the position of the rotor. The drive shaft may be coupled to the rotor and rotatably supported within the housing.

When the rotor is in a first position of rotation, a first rotor fluid port is in fluid communication with the pintle inlet so that hydraulic fluid is drawn from the hydraulic fluid inlet into the first rotor fluid port via the pintle inlet and then flows into a first cylinder or a first cylinder set associated with the first rotor fluid port, pushing the first cylinder or the first cylinder set radially outwardly. When the rotor is in a second position opposite to the first position, the first rotor fluid port is in fluid communication with the pintle outlet so that the drawn hydraulic fluid is discharged from the first cylinder or the first cylinder set and flows from the first rotor fluid port into the hydraulic fluid outlet via the pintle outlet.

In another example, the pintle may include a mounting flange that is attached to the housing. The mounting flange may be fixed to the housing via fasteners.

In some examples, the radial piston device may include a flexible coupling for coupling the drive shaft with the rotor. The flexible coupling may define an inlet in fluid communication with the hydraulic fluid inlet and the pintle inlet.

In other examples, the housing may include a drive shaft housing having a hydraulic fluid inlet and a rotor housing having a hydraulic fluid outlet. The pintle may be attached or fixed to the rotor housing so as to be accommodated within the rotor housing. The drive shaft may be supported within the drive shaft housing.

The radial piston device may be used either as a pump or as a motor.

The radial piston device according to the present disclosure may further include a mechanism for minimizing deflection or curvature of the pintle shaft, which may be caused by a resulting pressure applied to the pintle shaft. Hydraulic fluid entering the cylinders and hydraulic fluid exiting the cylinders exert different pressures on the pintle shaft at different sides, thereby creating a resulting pressure on the pintle shaft. Such a resulting pressure applied to the pintle shaft causes deflection or curvature of the pintle shaft along the pintle axis of rotation.

In one aspect, the rotor is at least partially supported by the housing with a bearing while being also supported by the pintle shaft with another bearing. In some examples, the rotor may be supported radially on the pintle shaft adjacent to the pintle outlet (or at an outlet end of the rotor) with a first bearing, and may be partially supported by the housing adjacent to the pintle inlet (or at an inlet end of the rotor) with a second bearing. The bearings may be a hydrodynamic journal bearing, which is also referred to as a fluid film bearing, or a hydrostatic bearing. In the examples in which the housing includes the drive shaft housing and the rotor housing, the rotor may be at least partially received within the drive shaft housing and rotatably supported by the drive shaft housing with a bearing.

In another aspect, the pintle has an inlet end and an outlet end, the outlet end opposite to the inlet end along the length of the pintle shaft, and the pintle shaft includes a tapered portion arranged around the pintle shaft at the inlet end of the pintle. The tapered portion of the pintle shaft is configured and arranged to compensate a deflection of the pintle shaft, thereby allowing the rotor to rotate around the deflected pintle shaft. In some examples, the tapered portion includes a first tapered portion and a second tapered portion. The first tapered portion may be arranged circumferentially around the pintle shaft adjacent the inlet end of the pintle, and the second tapered portion may be arranged circumferentially around the pintle shaft adjacent the outlet end of the pintle. The tapered portion may have a cone shape. In some examples, the cone shape may be arranged circumferentially around the pintle shaft adjacent the inlet end of the pintle and configured to have an apex of the cone shape biased in a direction opposite to the inlet end of the pintle.

In still other aspects, the rotor and the drive shaft may be integrally formed as one piece.

In still other aspects, the pintle shaft may be at least partially supported by the drive shaft, and the drive shaft may be engaged at least partially with the pintle shaft and rotatable with respect to the pintle shaft. In some examples, the drive shaft has a driving end and a power transfer end that is opposite to the driving end along a drive shaft axis of rotation. The drive shaft may have a receiving portion formed at the power transfer end for at least partially receiving the pintle shaft therein so that the pintle shaft may be partially supported in the receiving portion of the drive shaft at the power transfer end. The receiving portion of the drive shaft is rotatably engaged at least partially with the pintle shaft at the power transfer end of the drive shaft. The drive shaft and the rotor may be coupled with a flexible coupling therebetween.

In still other aspect, the drive shaft and the rotor may be coupled by spline coupling. In some examples, the drive shaft has a shaft head, a stem and a power transfer flange. The stem extends between the shaft head and the power transfer flange. The power transfer flange may be coupled to the rotor by spline coupling, in other examples, the power transfer flange has a coupling portion protruding therefrom. The coupling portion may have a number of splines located on an outer surface thereof, and the rotor may have a number of corresponding splines located on an inner surface of the bore of the rotor at the inlet end. The splines of the coupling portion are engaged with the corresponding splines of the rotor.

In still other aspect, the pintle may have has an inlet end and an outlet end that is opposite to the inlet end along a pintle shaft axis. The pintle may include a mounting flange located at the outlet end of the pintle and attached to the rotor housing, and the pintle shaft may include at least one undercut section around the pintle shaft adjacent the mounting flange.

### BRIEF DESCRIPTION OF THE DRAWINGS

FIG. 1 is a side sectional view of a radial piston device according to one example of the present disclosure.

FIG. 2 is an exploded view of rotor, a drive shaft and a flexible coupling of the radial piston device of FIG. 1.

FIG. 3 is a side view of the combination of the rotor, the drive shaft and the flexible coupling of FIG. 2.

FIG. 4 is a sectional perspective view of an example pintle, of the radial piston device of FIG. 1.

FIG. 5 is an end sectional view of the radial piston device of FIG. 1 with the housing removed.

FIG. 6 is a side sectional view of a radial piston device according to a second example of a mechanism for eliminating the effect of the pressure difference against a pintle shaft in accordance with the principles of the present disclosure.

FIG. 7A is a side view of the pintle shaft of FIG. 6, illustrating example tapered portions of FIG. 6.

FIG. 7B is an enlarged view of a first tapered portion of FIG. 7A.

FIG. 7C is an enlarged view of a second tapered portion of FIG. 7A.

FIG. 7D is a schematic view of a deflected pintle shaft having the first and second tapered portions of FIG. 7A.

FIG. 8 is a side sectional view of a radial piston device according to a third example of a mechanism in accordance with the principles of the present disclosure for eliminating the effect of the pressure difference against a pintle shaft.

FIG. 9 is a side sectional view of a radial piston device according to a fourth example of a mechanism in accordance with the principles of the present disclosure for eliminating the effect of the pressure difference against a pintle shaft.

FIG. 10 is a side sectional view of a radial piston device according to a fifth example of a mechanism in accordance with the principles of the present disclosure for eliminating the effect of the pressure difference against a pintle shaft.

FIG. 11 is a side sectional view of a radial piston device according to a sixth example of a mechanism in accordance with the principles of the present disclosure for eliminating the effect of the pressure difference against a pintle shaft.

### DETAILED DESCRIPTION

Various examples will be described in detail with reference to the drawings, wherein like reference numerals represent like parts and assemblies throughout the several views. Reference to various examples does not limit the scope of the disclosure and the aspects upon which the examples are based. Additionally, any examples set forth in this specification are not intended to be limiting and merely set forth some of the many possible ways in which the various aspects of the present disclosure may be put into practice.

In the present disclosure, radial piston devices are described generally. These devices may be used in both motor and pump applications, as required. Certain differences between motor and pump applications are described herein when appropriate, but additional differences and similarities would also be apparent to a person of skill in the art. The radial piston device disclosed herein exhibits high power density, is capable of high speed operation, and has high efficiency. Although the technology herein is described in the context of radial piston devices, the benefits of the technologies described may also be applicable to any device in which the pistons are oriented between an axial position and a radial position.

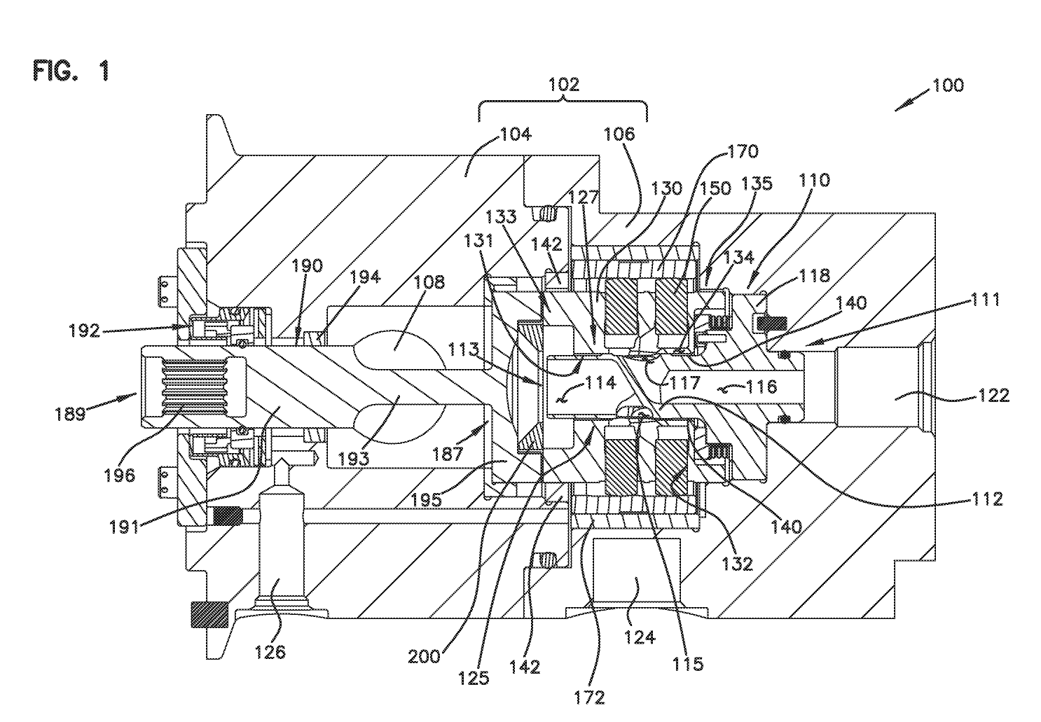

FIG. 1 is a side sectional view of a radial piston device 100 according to one example of the present disclosure. The radial piston device 100 includes a housing 102, a pintle 110, a rotor 130, a plurality of pistons 150, a thrust ring 170, and a drive shaft 190. The radial piston device 100 may be used as a pump or a motor. When the device 100 operates as a pump, torque is input to the drive shaft 190 to rotate the rotor 130. When the device 100 operates as a motor, torque from the rotor 130 is output through the drive shaft 190.

The housing 102 may be configured as a two-part housing that includes a drive shaft housing 104 and a rotor housing 106. The drive shaft housing 104 includes a hydraulic fluid inlet 108 through which hydraulic fluid is drawn into the drive shaft housing 104 when the device 100 operates as a pump. The rotor housing 106 includes a hydraulic fluid outlet 122 through which hydraulic fluid is discharged when the device 100 operates as a pump.

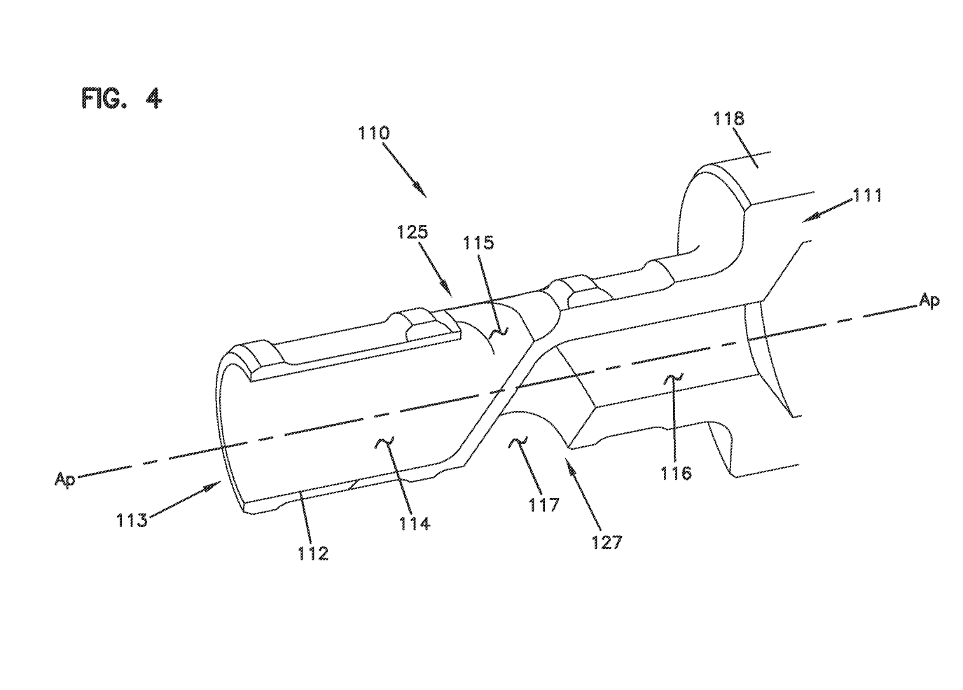

The pintle 110 has a first end 111 (also referred to herein as an outlet end) and a second end 113 (also referred to herein as an inlet end) that is opposite to the first end along a pintle axis A_{P} (FIG. 4). The pintle 110 includes a pintle shaft 112 that protrudes from the first end 111 of the pintle 110 along the pintle axis A_{P} so that the pintle axis A_{P} extends through a length of the pintle shaft 112. The pintle shaft 112 has a cantilevered configuration and includes a base end positioned adjacent the first end 111 of the pintle 110 and a free end positioned adjacent the second end 113. The pintle 110 is accommodated within the rotor housing 106 and fixed to the rotor housing 106 at the first end of the pintle 110. The pintle 110 includes a mounting flange 118 at the first end of the pintle 110, and the mounting flange 118 is attached to the rotor housing 106 via fasteners (not shown). The pintle shaft 112 defines a pintle inlet 114 and a pintle outlet 116 therethrough. The pintle inlet 114 and the pintle outlet 116 are substantially aligned with the pintle axis A_{P}. The pintle inlet 114 is in fluidic communication with the hydraulic fluid inlet 108, and the pintle outlet 116 is in fluidic communication with the hydraulic fluid outlet 122.

The pintle 110 may further include an inlet port 115 and an outlet port 117. The inlet port 115 and the outlet port 117 are formed on the pintle shaft 112. In some examples, the inlet port 115 is arranged substantially opposite to the outlet port 117 on the pintle shaft 112. The inlet port 115 is configured to be in fluid communication with the pintle inlet 114, and the outlet port 117 is configured to be in fluid communication with the pintle outlet 116.

The rotor 130 defines a bore 131 that allows the rotor 130 to be mounted on the pintle shaft 112. The rotor 130 has an inlet end 133 and an outlet end 135 that is opposite to the inlet end 133 along a rotor axis A_{R}. The rotor axis A_{R} extends through the length of the pintle shaft 112 and is coaxial with the pintle axis A_{P}. The rotor 130 is mounted on the pintle shaft 112 so that the outlet end 135 of the rotor 130 is arranged adjacent the first end 111 of the pintle 110 (which is adjacent the mounting flange 118). The inlet end 133 of the rotor 130 is coupled to the drive shaft 190 as explained below.

The rotor 130 is configured to rotate relative to the pintle 110 on the pintle shaft 112 about the rotor axis A_{R}. The rotor 130 defines a number of radial cylinders 132, each of which receives a piston 150. In the depicted example, the cylinders 132 are in paired configurations such that two cylinders 132 are located adjacent each other along a linear axis parallel to the rotor axis A_{R}. In the present application, such linearly-aligned cylinders 132 and pistons 150 are referred to as cylinder sets and piston sets, respectively.

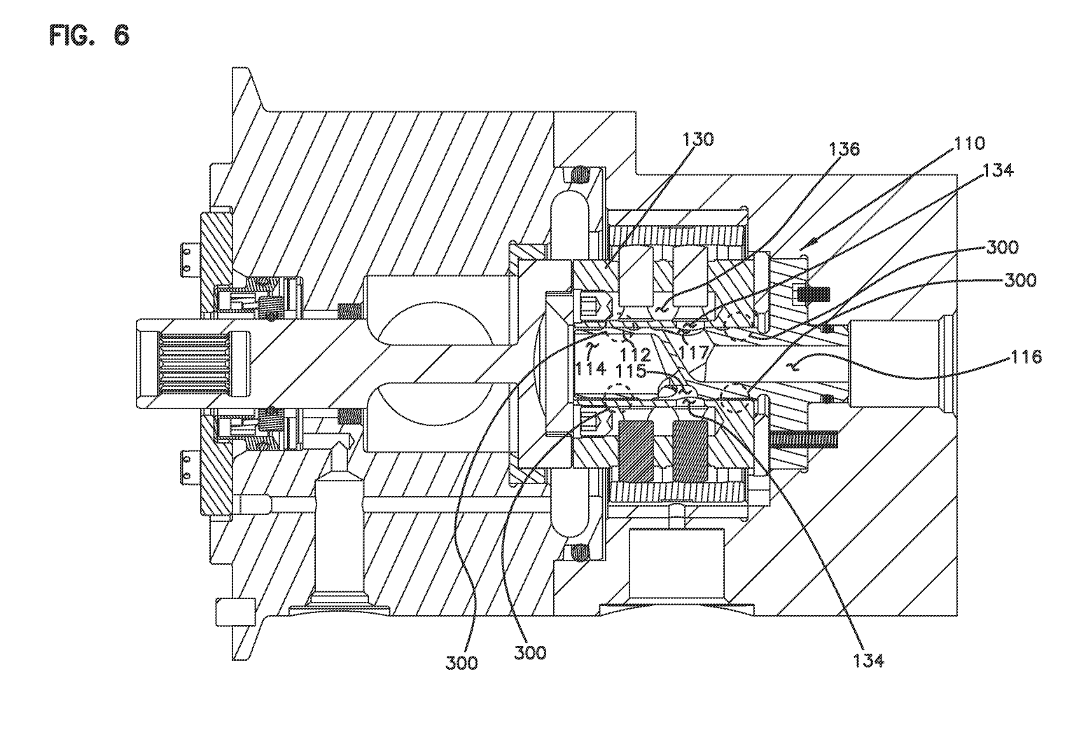

The rotor 130 includes rotor fluid ports 134 and common fluid chambers 136 (FIG. 6). Each of the common fluid chambers 136 are arranged below each of cylinder sets. The rotor fluid ports 134 are configured to allow for fluidic communication with the common fluid chambers 136, respectively. Each of the rotor fluid ports 134 is alternatively in fluid communication with either the pintle inlet 114 through the inlet port 115 of the pintle 110 or the pintle outlet 116 through the outlet port 117 of the pintle 110, depending on a rotational position of the rotor 130 relative to the pintle 110 about the rotor axis A_{R}.

The pistons 150 are received in the radial cylinders 132 defined in the rotor 130 and displaceable in the radial cylinders 132, respectively. Each piston 150 is in contact with the thrust ring 170 at a head portion of the piston 150.

The thrust ring 170 is supported radially by the rotor housing 106 and rotatably mounted in the rotor housing 106. The thrust ring 170 may be supported with a hydrodynamic journal bearing 172.

The drive shaft 190 is at least partially located within the drive shaft housing 104. An oil seal assembly 192 surrounds the drive shaft 190 and prevents hydraulic fluid from inadvertently exiting the housing 102. The drive shaft 190 is supported with a plurality of alignment bushings 194 such that there is no radial load on the drive shaft 190.

The drive shaft 190 has a driving end 187 and a power transfer end 189, which is opposite to the driving end 187 along a drive shaft axis of rotation A_{S}. In some examples, the drive shaft 190 includes a shaft head 191, a stem 193 and a power transfer flange 195. The shaft head 191 is configured to be engaged with a driving mechanism (not shown) at the driving end 187 of the drive shaft 190 so that torque is input to the drive shaft 190 to rotate the rotor 130 when the radial piston device 100 operates as a pump. A power transfer flange 195 is configured to be engaged with the rotor 130. The stem 193 extends between the shaft head 191 and the power transfer flange 195. In sonic examples, the drive shaft 190 is located within the drive shaft housing 104 such that hydraulic fluid entering the drive shaft housing 104 via the hydraulic fluid inlet 108 flows around the stem 193 of the drive shaft 190 and into the pintle inlet 114 of the pintle shaft 112.

The drive shaft 190 is configured to be connected to the rotor 130 at the power transfer end 189 of the drive shaft 190. In some examples, the drive shaft 190 is connected to the inlet end of the rotor 130 at a flexible coupling 200. For example, the power transfer flange 195 of the drive shaft 190 may be connected to the inlet end of the rotor 130 with the flexible coupling 200 therebetween.

The radial piston device 100 may further include an apparatus for monitoring temperature and/or pressure within the housing 102. Such a monitoring apparatus may be arranged at a number of different locations including a sensor port 124. The radial piston device 100 may include a case drain 126 that is connected to any number of interior chambers of the housing 102.

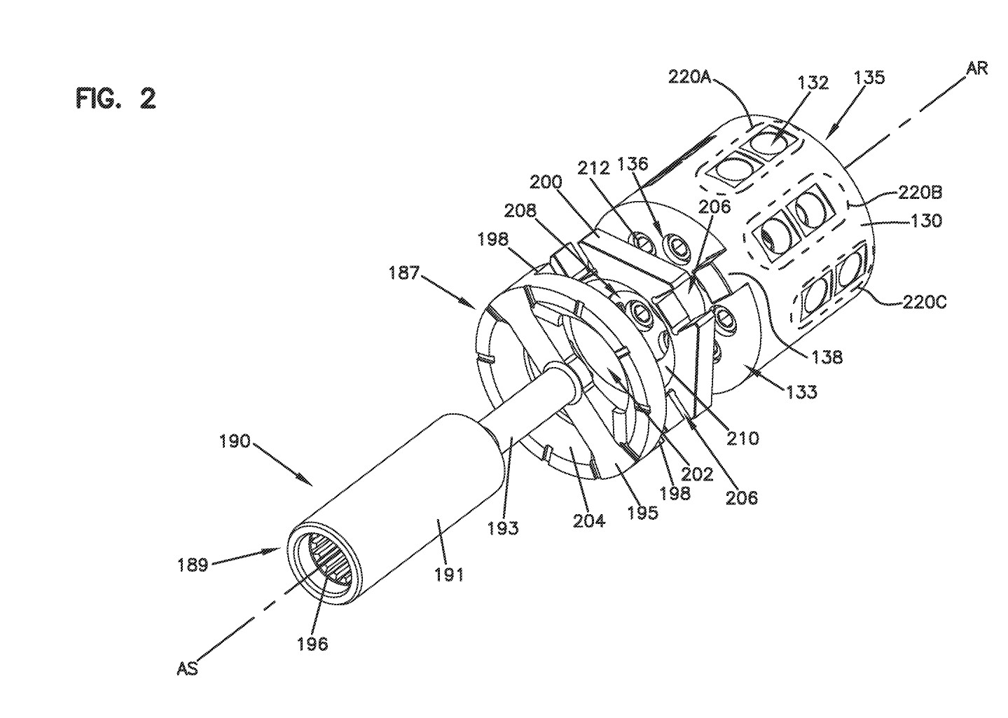

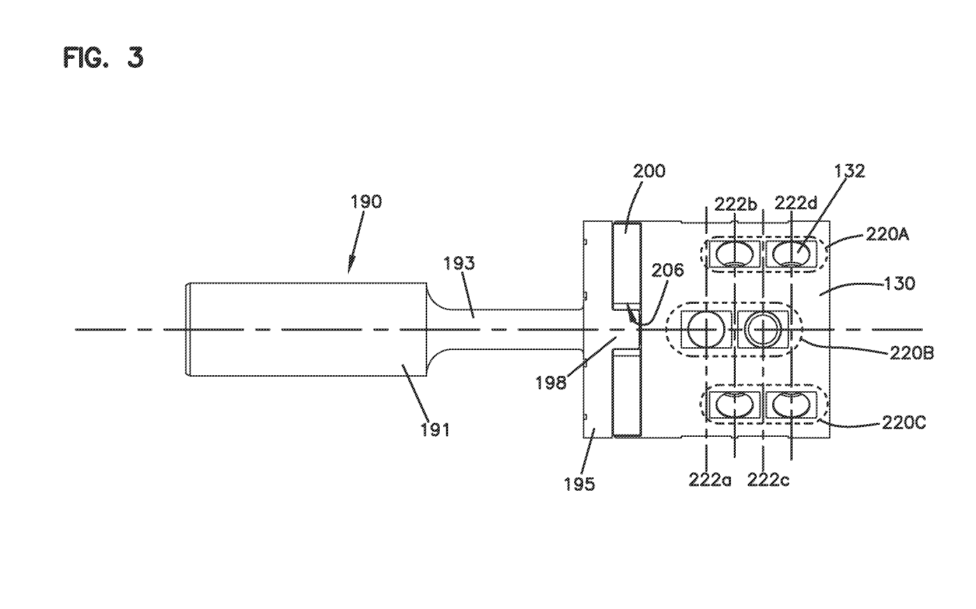

FIGS. 2 and 3 illustrate the rotor 130, the drive shaft 190 and the flexible coupling 200 according to one example of the present disclosure. FIG. 2 is an exploded view of the rotor 130, the drive shaft 190 and the flexible coupling 200. FIG. 3 is a side view of the combination of the rotor 130, the drive shaft 190 and the flexible coupling 200. The rotor 130 is engaged with the drive shaft 190 via the flexible coupling 200.

The drive shaft 190 includes a number of drive splines 196 at the shaft head 191 of the drive shaft 190. In some examples, the drive splines 196 are formed within the shaft head 191. In other examples, the splines may be arranged on an outer surface of the shaft head 191. As explained above, the drive shaft 190 includes the power transfer flange 195 at an end of the drive shaft 190 opposite to the shaft head 191 having the drive splines 196. The power transfer flange 195 includes a number of shaft teeth 198 to engage the flexible coupling 200. In this example, two shaft teeth 198 engage the flexible coupling 200 at an angle of about 90 degrees from two rotor teeth 138 that also engage the flexible coupling 200. The power transfer flange 195 at the power transfer end of the drive shaft 190 that supports the shaft teeth 198 defines one or more flow passages 202 that allow hydraulic suction flow to pass into the center of the flexible coupling 200. The drive shaft flow passage 202 may include a tapered or funneled inner surface 204 that reduces pressure losses as the hydraulic fluid is drawn into the pintle inlet 114.

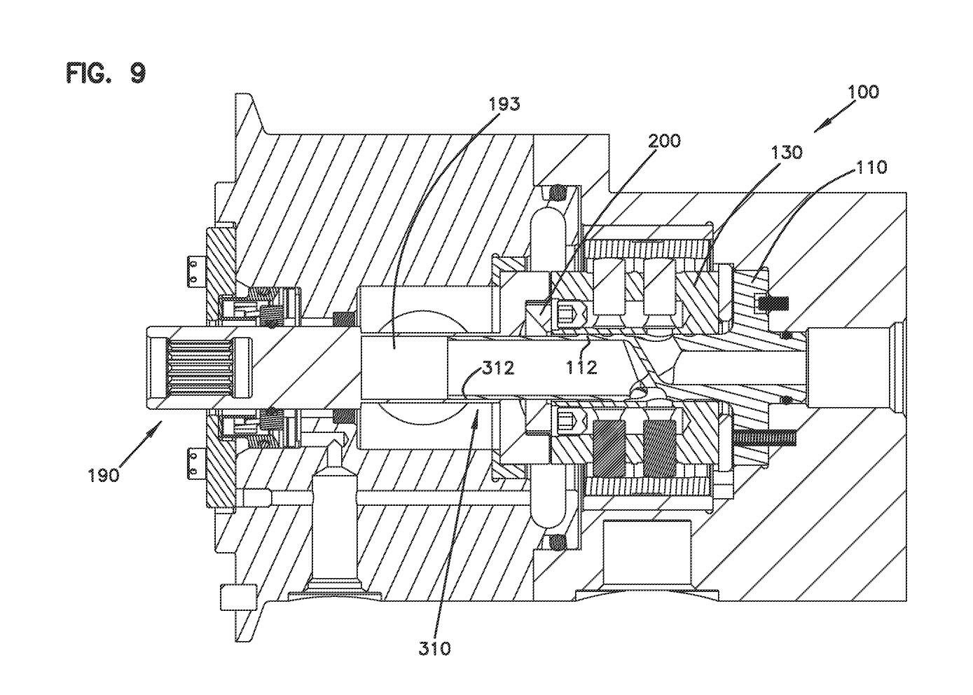

The flexible coupling 200 defines a number of receivers 206 for receiving the shaft teeth 198 and the rotor teeth 138. The flexible coupling 200 defines a flow passage 208 to collect the hydraulic suction flow into the pintle inlet 114 (not shown in FIGS. 2 and 3). Just as the tapered or funneled inner surface 204 of the drive shaft flow passage 202, the flexible coupling flow passage 208 may include a tapered or funneled inner surface 210 that reduces pressure losses as the hydraulic fluid is drawn into the pintle inlet 114. Use of the flexible coupling 200 allows for misalignment between the rotor axis A_{R} and a shaft axis A_{S}. This misalignment prevents radial loading of the drive shaft 190, and allows the rotor 130 to float freely on the pintle journal bearings. In some examples, however, the drive shaft 190 and rotor 130 may be directly engaged with each other, without the use of the flexible coupling 200, as exemplified below with reference to FIG. 9 or 11.

In this example, each cylinder set 220A is offset from an adjacent cylinder set 220B, such that four rows 222a, 222b, 222c and 222d are present on the rotor 130 (See FIG. 3). The rows 222a, 222b, 222c and 222d extend in a circumferential direction about the rotor and are axially offset from one another. In general, axial offsetting the rows of cylinder sets, and of piston sets therein, around the rotor 130 allows the overall size of the rotor 130 (and therefore the device 100) to be reduced. Additionally, the offsetting of the cylinder/piston rows balances the thrust loads on the rotor that are generated due to contact between the thrust ring 170 and the pistons 150.

A minimum of two rows 222 are necessary to balance the thrust loads on the thrust ring. In other examples, other numbers of rows and shafts may be utilized. In this example, four piston rows 222a, 222b, 222c and 222d are utilized. As noted above with regard to FIG. 1, the common fluid chambers 136 are in fluidic communication with both cylinders 132 of each cylinder set 220A or 220B. This helps reduce the high pressure footprint between the rotor 130 and pintle, 110 in order to achieve a more balanced radial load on the pintle journals. The common fluid chambers 136 are blocked with set screws 212. In alternative examples, common plugs, Welch plugs, brazed plugs, mechanically 2.0 locked plug pins (i.e., Lee plugs), cast-in plugs, or weldments may be utilized to block the common fluid chambers 136.

FIG. 4 is a sectional perspective view of an example pintle 110 of the radial piston device 100 according to the present disclosure. As depicted, the pintle inlet 114 and the pintle outlet 116 are substantially aligned with the pintle axis A_{P} and open at the opposite surfaces of the pintle shaft 112, respectively. Accordingly, hydraulic fluid flow is directed axially through opposing ends of the pintle 110. As explained above with reference to FIG. 1, either the inlet port 115, which is in fluid communication with the pintle inlet 114, or the outlet port 117, which is in fluid communication with the pintle outlet 116, is in fluid communication with the corresponding common fluid chamber 136 through the corresponding rotor fluid port 134, depending on the position of the rotor 130 as the rotor 130 rotates with respect to the pintle shaft 112 about the rotor axis A_{R} (or the pintle axis A_{P}). In the illustrated configurations, when the device 100 operates as a pump, fluid flow is drawn axially into the pintle inlet 114 along the pintle axis A_{P}. The hydraulic fluid is drawn through the inlet port 115 of the pintle 110 and then through the rotor fluid port 134 that is matched with the inlet port 115 depending on the rotational position of the rotor 130 with respect to the pintle shaft 112. The hydraulic fluid flow is then drawn radially outward into the rotor cylinders 132 via the common fluid chamber 136. The exit (i.e., outlet) flow from the rotor 130 is forced through the pintle outlet 116 (radially inward) via the outlet port 117 of the pintle 110 and then flows axially toward the hydraulic fluid outlet 122 at the opposite end of the radial piston device 100.

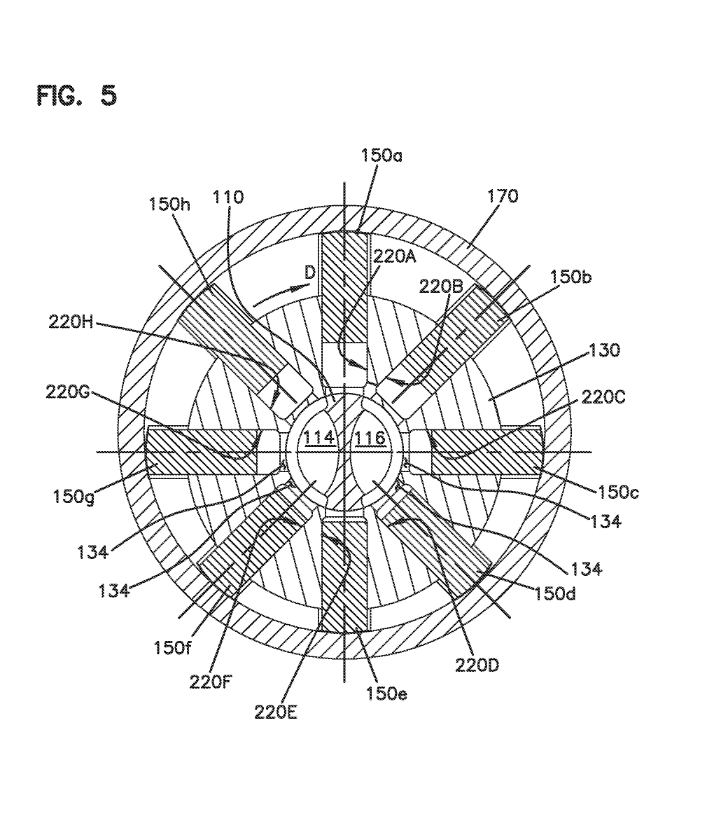

FIG. 5 is an end sectional view of the radial piston device 100 of FIG. 1 with the housing 102 removed. As shown in FIG. 5, the rotor axis A_{R} is aligned with the pintle axis A_{P}, but the rotor axis A_{R} and the pintle axis A_{P} are not coaxial with a thrust ring axis of rotation. The plurality of pistons 150 reciprocate radially within the rotor 130 as the rotor 130 rotates about the pintle shaft 112 to draw fluid into the cylinders during outward strokes of the pistons and to force fluids from the cylinders during inward strokes of the pistons. Reciprocation of the pistons 150 occurs due to a radial offset (i.e., eccentricity) between the thrust ring 170 and the rotor 130. As a result, the pistons 150 pump once per revolution of the rotor 130 (i.e., the pistons move through one in-stroke and one out-stroke per revolution of the rotor). As shown in FIG. 5, piston 150a is located at bottom dead center (BDC) position (the full out-stroke position) and piston 150e is located at top dead center (TDC) position (the full in-stroke position). When the rotor 130 is in a position as illustrated in FIG. 5, the rotor fluid ports 134 for the cylinder sets 220F, 220G and 220H are in fluidic communication with the pintle inlet 114. In the same position of the rotor 130, the rotor fluid ports 134 for the cylinder sets 220B, 220C and 220D, which are located opposite to the cylinder sets 220F, 220G and 220H, respectively, are in fluidic communication with the pintle outlet 116. In this position, when the device 100 is operated as a pump and the rotor 130 is rotated by the drive shaft in a direction D, hydraulic fluid is drawn from the hydraulic fluid inlet 108 and flows into the rotor fluid ports 134 for the cylinder sets 220F, 220G and 220H, as the piston sets 150f, 150g and 150h move radially outward in the associated cylinder sets due to the interaction between the rotor 130 and the thrust ring 170. Concurrently, hydraulic fluid is forced from the cylinder sets 220B, 220C and 220D through the corresponding rotor fluid ports 134 and discharged to the hydraulic fluid outlet 122 via the pintle outlet 116 as the pistons sets 150b, 150c and 150d move radially inwardly due to interaction between the rotor 130 and the thrust ring 170.

The interface between the pistons 150 and the inner race of the thrust ring 170 is defined by a spherical piston geometry and a toroidal ring geometry. This promotes rolling of the pistons 150 on the thrust ring 170 in order to prevent sliding. An even number of cylinder sets are used in order to balance the thrust loads acting on the thrust ring 170. In the depicted example, eight cylinder sets are utilized. Special materials or coatings (such as ceramics or nanocoatings) can be used to decrease the friction and increase the longevity of the piston/ring interface.

As shown in FIG. 5, the pintle shaft 112 has an inlet side 125 (i.e., a side adjacent the inlet port 115) and an opposite outlet side 127 (i.e., a side adjacent the outlet port 117). Because the first end of the pintle 110 is fixed to the rotor housing 106 with the mounting flange 118 of the pintle 110 while the second end 113 is unsupported, the pintle shaft 112 operates just as a cantilever along the pintle axis A_{P}. Fluid entering the cylinders 132 of the rotor 130 through the inlet port 115 from the pintle inlet 114 has a lower pressure than a fluid discharging from the cylinders 132 of the rotor 130 to the pintle outlet 116 through the outlet port 117. Thus, pressure load on the outlet side 127 of the pintle shaft 112 is greater than the pressure load on the inlet side 125 of the pintle shaft 112. This pressure difference causes an unbalanced load to be applied to the pintle shaft 112 which causes the pintle shaft 112 to deflect in a curvature along its length with maximum deflection at the free end and no or minimal deflection at the fixed base end of the pintle shaft 112. The curvature of the pintle shaft 112 can cause misalignment with the rotor 130, preventing the rotor 130 from rotating about the pintle shaft 112 as designed.

The radial piston device 100 may include several mechanisms for reducing such deflection of the pintle shaft 112 along the pintle axis A_{P} due to hydraulic fluid pressure on the pintle shaft 112, and/or for minimizing the consequences of the pintle shaft deflection, such as misalignment between the pintle shaft 112 and the rotor 130. The mechanisms are hereinafter explained in detail. In some examples, each of the mechanisms may be separately implemented in a radial piston device 100. In other examples, any combination of the mechanisms may be used for the radial piston device.

Turning again to FIG. 1, FIG. 1 shows a first example of a mechanism for eliminating the consequences of the difference in fluid pressure on the pintle shaft 112. In this example, the rotor 130 is arranged to be at least partially accommodated within the drive shaft housing 104 and rotatably supported by the drive shaft housing 104 at the inlet end 133 of the rotor 130, which is adjacent to the second end or inlet end 113 of the pintle 110 (i.e., adjacent the free end of the pintle shaft). When the rotor 130 rotates, the portion of the rotor 130 at its inlet end 133 that is supported by the drive shaft housing 104 slides relative to the corresponding inner surface of the drive shaft housing 104 with a journal bearing 142 interposed therebetween. In some examples, a hydrodynamic journal hearing, which is also known as a fluid film hearing, or a hydrostatic hearing may be used as the bearing 142 between the rotor 130 and the drive shaft housing 104.

When the rotor 130 is partially supported by the drive shaft housing 104 at the inlet end 133 of the rotor 130 with a journal bearing, the rotor 130 need not be additionally supported by the pintle shaft 112 at multiple locations on the length of the pintle shaft 112. Instead, in some examples, the pintle shaft 112 may only support the rotor 130 adjacent to the fixed/base end of the pintle shaft 112. This is significant because the base/fixed end of the pintle shaft 112 does not experience much or any deflection in use of the device. By supporting the rotor 130 at a location along the shaft 130 that does not experience substantial deflection, rotation of the rotor 130 on the pintle shaft 112 is not negatively affected by the pintle shaft deflection. In certain examples, a larger radial clearance (or spacing or gap) can be provided between the pintle shaft 112 and the rotor 130 at the region of the pintle shaft 112 that experiences the most deflection in use of the device so as to avoid unwanted contact between the pintle shaft 112 and the rotor 130 as the pintle shaft 112 deflects due to unbalanced pressure applied to the inlet and outlet sides 125 and 127. In certain examples, a bearing is provided between the pintle shaft 112 and the rotor 130 at a position that is spaced no more than ¼ of the length of the shaft from the base end of the pintle shaft 112, and no bearings are provided between the rotor 130 and the shaft 112 for the remaining ¾ of the length of the pintle shaft 112. In other examples, a bearing is provided between the pintle shaft 112 and the rotor 130 at a position that is spaced no more than ⅓ of the length of the pintle shaft 112 from the base end of the shaft, and no bearings are provided between the rotor 130 and the pintle shaft 112 for the remaining ⅔ of the length of the pintle shaft 112. In other examples, a bearing is provided between the pintle shaft 112 and the rotor 130 at a position that is spaced no more than ½ of the length of the shaft from the base end of the pintle shaft 112, and no bearings are provided between the rotor 130 and the pintle shaft 112 for the remaining ½ of the length of the pintle shaft 112.

As shown in FIGS. 1 and 6, the rotor 130 is rotatably supported by the pintle shaft 112 with a journal bearing 140 only at the outlet end of the rotor 130, which is adjacent to the pintle outlet 116 (i.e., adjacent the base end of the pintle shaft 112). In some examples, the journal bearing 140 may be a hydrodynamic journal bearing or a hydrostatic bearing. Support of the rotor 130 by the drive shaft housing 104 allows eliminating a journal bearing that is typically used between the inner diameter of the rotor 130 and the outer diameter of the pintle shaft 112 at the inlet end 133 of the rotor 130 (i.e., adjacent the free end of the pintle shaft 112). As a result, it allows a loose clearance between the inner diameter of the rotor 130 and the outer diameter of the pintle shaft 112 at the inlet end 133 of the rotor 130 (i.e., adjacent the free end of the shaft 112). Furthermore, this configuration minimizes the consequences of deflection or curvature of the pintle shaft 112 along the pintle axis A_{P}, which results from unbalanced pressures applied to the pintle shaft 112 by hydraulic fluid entering and exiting the common fluid chambers 136 and the cylinders 132 of the rotor 130.

FIG. 6 is a side sectional view of a radial piston device 100 according to a second example of a mechanism for eliminating the consequences of the pressure difference against the pintle shaft 112. In this example, the pintle shaft 112 includes one or more tapered portions 300 thereon for compensating deflection of the pintle shaft 112 along the pintle axis A_{P}, thereby allowing the rotor 130 to rotate around the pintle shaft 112 although the pintle shaft 112 deflects along the pintle axis A_{P}. The tapered portions 300 are configured in such a manner that, when the pintle shaft 112 deflects due to fluid load, the pintle shaft 112 has its outer surface parallel with the inner surface of the rotor 130 that engages with the outer surface of the pintle shaft 112.

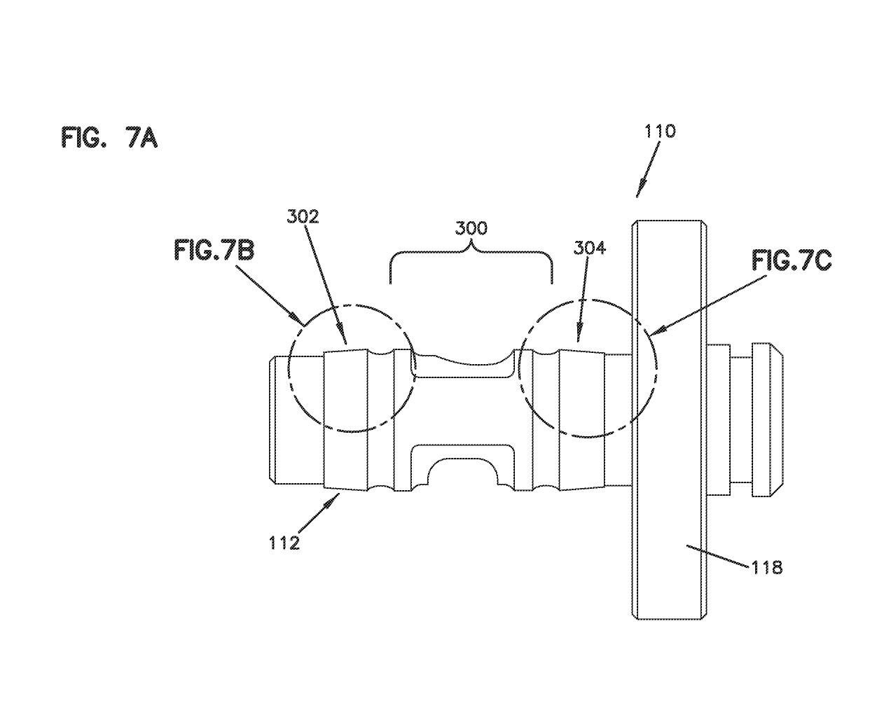

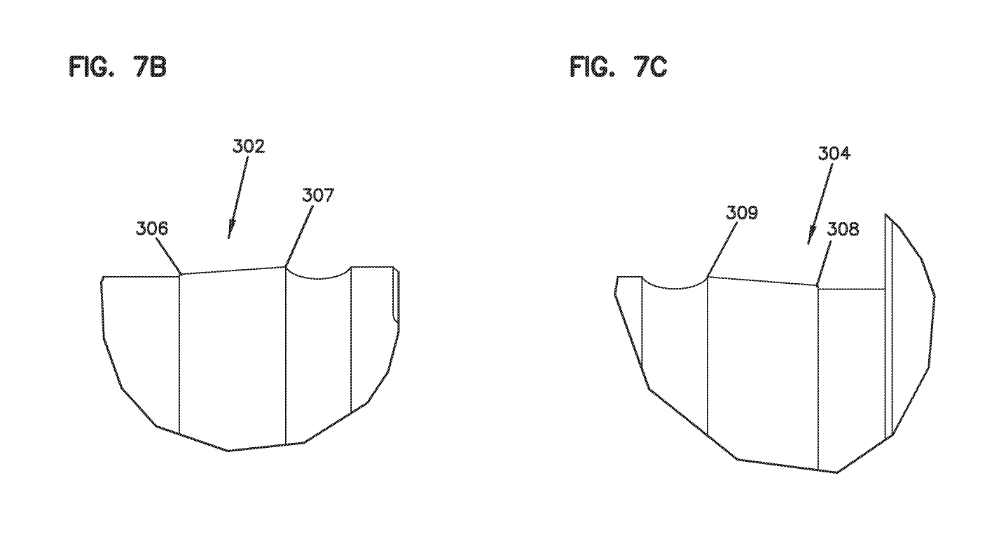

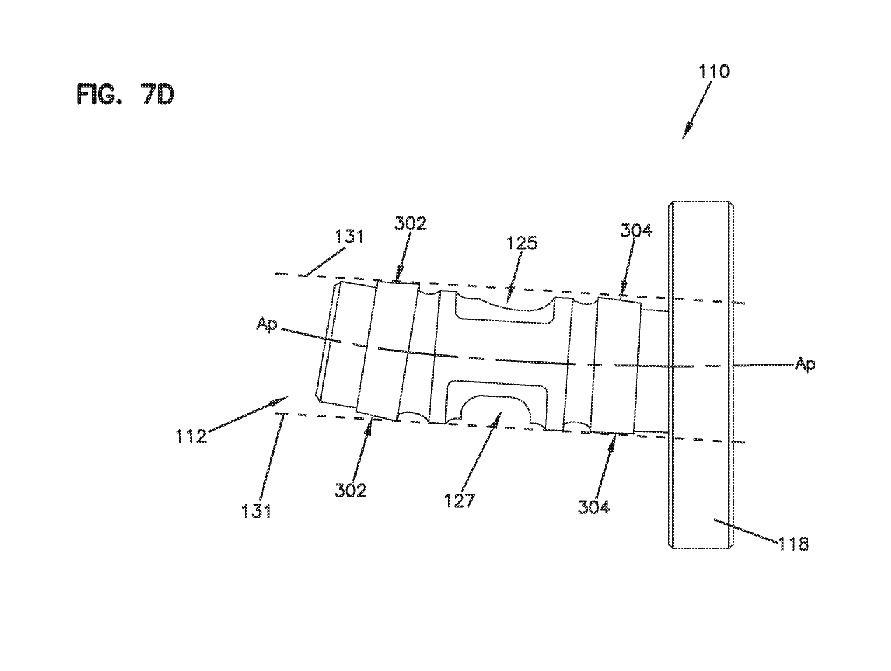

FIG. 7A is a side view of the pintle shaft 112, illustrating example tapered portions 300 of FIG. 6. FIGS. 7B and 7C are enlarged views of the tapered portions 300 of FIG. 7A. In this example, the tapered portions 300 have a first tapered portion 302 and a second tapered portion 304. The first tapered portion 302 is arranged circumferentially around the pintle shaft 112 adjacent the inlet end of the pintle shaft 112. The second tapered portion 304 is arranged circumferentially around the pintle shaft 112 adjacent the base end of the pintle shaft 112, which is close to the mounting flange 118.

The tapered portions 300 may be configured as a truncated conical shape. In some examples, the first tapered portion 302 has a minor diameter 306 of the conical shape closest to the inlet end (i.e., the free end) of the pintle shaft 112 and a major diameter 307 farthest from the inlet end (i.e., the inlet end) of the pintle shaft 112. Thus, a cross section of the first tapered portion 302 has a diameter gradually decreasing as it goes along the length of the pintle shaft 112 in a direction toward the inlet end of the pintle shaft 112. In contrast, the second tapered portion 304 has a minor diameter 308 of the conical shape closest to the outlet end (i.e., the base or fixed end) of the pintle shaft 112 and a major diameter 309 furthest from the outlet end (i.e. the base or fixed end) of the pintle shaft 112. Thus, the second tapered portion 304 may have a cross section with a diameter gradually decreasing as it goes along the length of the pintle shaft 112 in a direction toward the outlet end of the pintle shaft 112. These faces of the first and second tapered portions 302 and 304 will engage in parallel with the inner surface of the rotor 130 when the pintle shaft 112 deflects along the pintle axis A_{P}.

FIG. 7D is a schematic view of the pintle shaft 112 that has deflected due to the unbalanced load applied to the pintle shaft 112. The deflection of the pintle shaft 112 as depicted in FIG. 7D is exaggerated to clearly show the geometry of the tapered portions 300 with respect to the rotor 130. As shown in FIG. 7D, greater pressure load on the outlet side 127 of the pintle shaft 112 than the pressure load on the inlet side 125 of the pintle shaft 112 causes the pintle shaft 112 to deflect upwardly along its length with maximum deflection at the free end and minimal deflection at the fixed or base end. As illustrated, in some cases, the rotor 130 slants as the pintle shaft 112 deflects due to pressure difference between the inlet side 125 and the outlet side 127. Thus, the dotted lines representing the bore 131 of the rotor 130 are illustrated to be tilted, following the deflection of the pintle shaft 112. When the pintle shaft 112 deflects, the first tapered portion 302 at the inlet side 125 and the second tapered portion 304 at the outlet side 127 are arranged substantially in parallel with the bore 131 (the dotted lines in FIG. 7D) of the rotor 130, respectively. As a result, the rotor 130 can smoothly engage the deflected pintle shaft 112, and maintain a small gap or clearance between the pintle shaft 112 and the inner surface of the bore 131 to provide reliable sealing thereon, thereby minimizing volumetric leakage and increasing volumetric efficiency.

Although FIG. 7A shows that the region between the first and second tapered portions 302 and 304 is illustrated to have an outer diameter that is the same as, or larger than, the major diameters 307 and 309 of the first and second tapered portions 302 and 304, the region between the first and second tapered portions 302 and 304 can have a smaller outer diameter than the minor diameters 306 and 308, or the major diameters 307 and 309, of the first and second tapered portions 302 and 304.

In other examples, the tapered portion 300 is arranged circumferentially around the pintle shaft 112 only at the inlet end of the pintle 110. In still other examples, while the tapered portion 300 is formed around the pintle shaft 112 adjacent to the inlet end of the pintle 110, it is arranged partially on a surface of the pintle shaft 112 adjacent the inlet port 115 of the pintle shaft 112. This is because, when the radial piston device is used as a pump, fluid has a higher pressure on a surface of the pintle shaft 112 adjacent to the outlet port 117 than on a surface of the pintle shaft 112 adjacent to the inlet port 115, which is substantially opposite to the outlet port 117 of the pintle shaft 112.

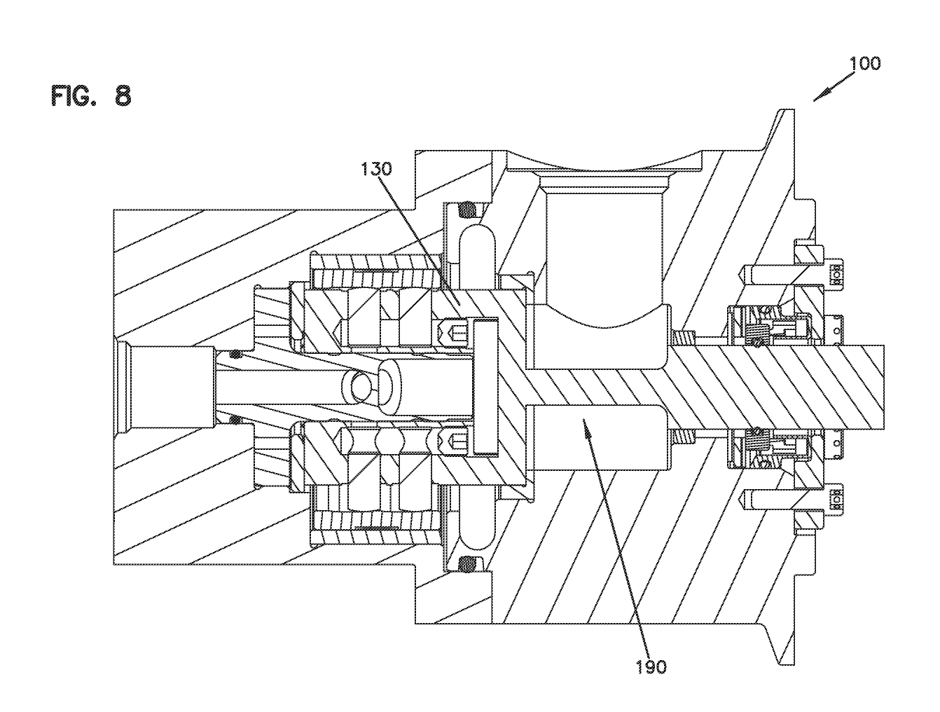

FIG. 8 is a side sectional view of a radial piston device 100 according to a third example of a mechanism for eliminating the consequences of the pressure difference against the pintle shaft 112. In this example, the rotor 130 and the drive shaft 190 is configured as one piece. Accordingly, there is no need of the flexible coupling 200 between the rotor 130 and the drive shaft 190 as shown in the previous examples. Such integral formation of the rotor 130 and the drive shaft 190 may alleviate a load on the pintle shaft 112 resulting from the pressure difference on different sides (i.e., the inlet side 125 and the outlet side 127) of the pintle shaft 112, thereby reducing a deflection of the pintle shaft 112.

In the third example, bearings that are arranged around the drive shaft 190 to support the drive shaft 190 also operate to support the rotor 130. Thus, a larger clearance can be provided between the pintle shaft 112 and the rotor 130 adjacent the free end of the pintle shaft 112 to allow for the pintle shaft deflection. Alternatively, the integral piece of the drive shaft 190 and the rotor 130 functions as support for the free end of the pintle shaft 112, thereby preventing the pintle shaft 112 from deflecting due to unbalance fluid pressure and maintaining co-axial alignment between the pintle shaft 112 and the rotor 130. In some examples, a bearing can be provided between the pintle shaft 112 and the rotor 130 adjacent the free end of the pintle shaft 112 for the integral piece of the drive shaft 190 and the rotor 130 to support the free end of the pintle shaft 112.

FIG. 9 is a side sectional view of a radial piston device 100 according to a fourth example of a mechanism for eliminating the consequences of the pressure difference against the pintle shaft 112. In this example, the pintle shaft 112 is at least partially supported by the drive shaft 190. The drive shaft 190 is engaged at least partially with the pintle shaft 112 while being rotatable with respect to the pintle shaft 112. This engagement reduces the curvature of the pintle shaft 112 along the pintle axis A_{P}, which results from the difference in pressure on different sides of the pintle shaft 112, and allows the pintle shaft 112 to maintain more linear or straight shape along the pintle axis A_{P}. For example, the drive shaft 190 supports the free end of the pintle shaft 112 so as to prevent the pintle shaft 112 from deflecting when exposed to uneven fluid pressures. In this way, in use, the pintle shaft 112 remains straight and does not deflect in a curved shape along its length. Such a straight shape of the pintle shaft 112, rather than a deflected shape, helps the rotor 130 to smoothly engage with the pintle shaft 112 when the rotor 130 rotates around the pintle shaft 112.

In some examples, the drive shaft 190 has a bore or receiving portion 310 formed within the stem 193 along the drive shaft axis A_{S}. The receiving portion 310 opens at the power transfer end of the drive shaft 190 and is configured to receive at least partially the pintle shaft 112 therein. To be received within the receiving portion 310 of the drive shaft 190, the pintle shaft 112 further extends at the inlet end or second end thereof along the pintle axis A_{P}, than the pintle shaft 112 of FIG. 1. As such, the pintle shaft 112 is partially supported in the receiving portion 310 of the drive shaft 190 at the power transfer end while being rotatably engaged with the receiving portion 310 of the drive shaft 190. A bearing 312 may be arranged between the receiving portion 310 of the drive shaft 190 and the outer surface of the pintle shaft 112 at its inlet end where the outer surface of pintle shaft 112 is rotatably engaged with the inner surface of the receiving portion 310 of the drive shaft 190. In some examples, the bearing 312 may be a hydrodynamic journal bearing or a hydrostatic bearing.

As in FIG. 1, in sonic examples, the rotor 130 and the drive shaft 190 may be coupled with a flexible coupling 200 therebetween. The flexible coupling 200 of this example may be configured just as the flexible coupling 200 of the previous examples.

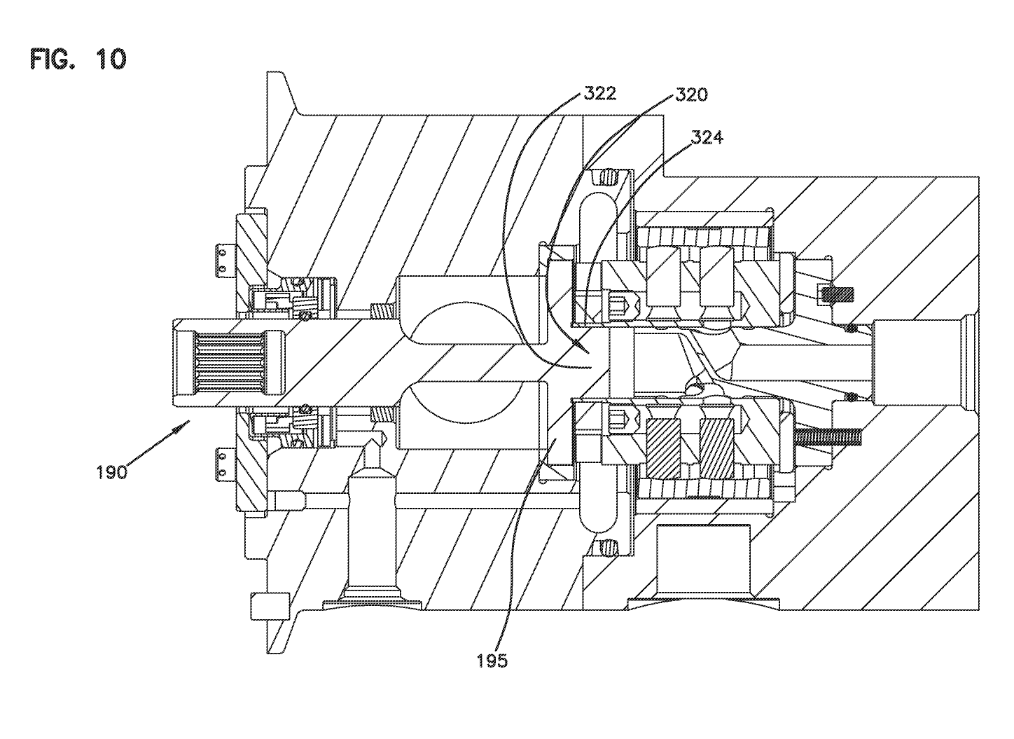

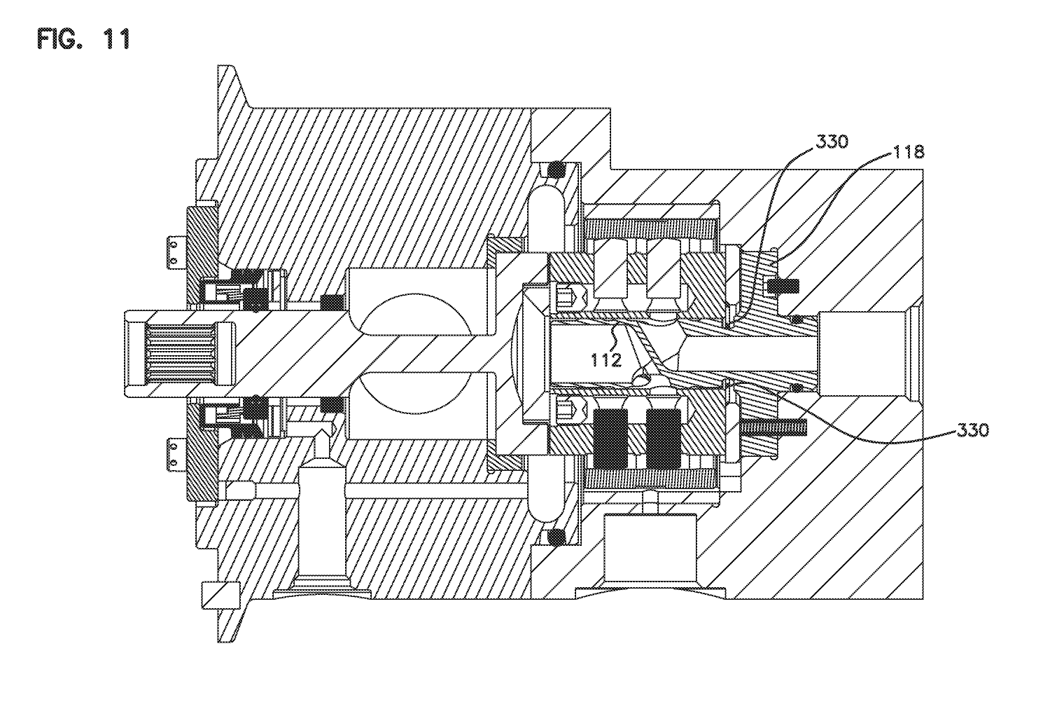

FIG. 10 is a side sectional view of a radial piston device 100 according to a fifth example of a mechanism for eliminating the consequences of the pressure difference against the pintle shaft 112. In this example, the drive shaft 190 is coupled with the rotor 130 by spline coupling 320. In particular, the power transfer flange 195 is configured to be coupled to the inlet end of the rotor 130 by spline coupling 320. Accordingly, there is no need of the flexible coupling 200 between the rotor 130 and the drive shaft 190 as shown in the previous examples. This spline coupling supports the rotor 130 radially at the inlet end of the rotor 130, thereby eliminating a load on the pintle shaft 112 resulting from the pressure difference on different sides (i.e., the inlet side 125 and the outlet side 127) of the pintle shaft 112, thereby reducing a deflection of the pintle shaft 112.

Similarly to the third example, in the fourth example, bearings that are arranged around the drive shaft 190 to support the drive shaft 190 also operate to support the rotor 130. Thus, a larger clearance can be provided between the pintle shaft 112 and the rotor 130 adjacent the free end of the pintle shaft 112 to allow for the pintle shaft deflection. Alternatively, the rotor 130 functions to support the free end of the pintle shaft 112, thereby preventing the pintle shaft 112 from deflecting due to unbalance fluid pressure and maintaining co-axial alignment between the pintle shaft 112 and the rotor 130. In some examples, a bearing can be provided between the pintle shaft 112 and the rotor 130 adjacent the free end of the pintle shaft 112 for the rotor 130 to support the free end of the pintle shaft 112.

In some examples, the drive shaft 190 includes a drive shaft side coupling portion 322 at the power flange end. For example, the drive shaft side coupling portion 322 is configured to protrude from the power transfer flange 195 along the drive shaft axis A_{S}. The drive shaft side coupling portion 322 has a number of splines located on an outer surface thereof. The rotor 130 can include a rotor side coupling portion 324 at the inlet end thereof. For example, the rotor side coupling portion 324 is configured to extend from the inlet end of the rotor 130 toward the power transfer flange 195 of the drive shaft 190. The rotor side coupling portion 324 has a number of splines, which are configured to correspond to the splines formed in the drive shaft side coupling portion 322. The number of splines of the rotor side coupling portion 324 is located on an inner surface of the bore of the rotor 130 at the inlet end. The splines of the drive shaft side coupling portion 322 are engaged with the corresponding splines of the rotor side coupling portion 324 to provide a torque transferring interface.

FIG. 11 is a side sectional view of a radial piston device 100 according to a sixth example of a mechanism for reducing the effects of pintle shaft deflection. In this example, the pintle shaft 112 has at least one undercut section 330 around the pintle shaft 112. The undercut section 330 can be referred to as a pre-defined flex location or a predefined hinge location. Such a location is a weakened region (e.g., a region of reduced cross-sectional area) that provides a preferred bend location. When exposed to uneven pressure loads, the pintle shaft 112 with such a pre-defined flex location bends at the discrete location defined by the weakened region rather than bending in a curved path along its length. In this way, portion of the shaft outside the preferred flex location shaft remains straight. In certain examples, the preferred flex location is spaced no more than of the length of the pintle shaft 112 away from the fixed end of the pintle shaft 112.

In some examples, the undercut section 330 is arranged around the pintle shaft 112 adjacent the mounting flange 118. The undercut section 330 may be configured as an annular groove formed circumferentially around the pintle shaft 112 adjacent the mounting flange 118. The undercut section 330 causes the pintle shaft 112 to have a smaller diameter at the undercut section 330 than at other portions of the pintle shaft 112. This structure reduces the curvature of the pintle shaft 112 along the pintle axis A_{P}, which results from the difference in pressure on different sides of the pintle shaft 112, and allows the pintle shaft 112 to maintain more linear or straight shape along the pintle axis A. Such a straight shape of the pintle shaft 112, rather than a deflected shape, helps the rotor 130 to smoothly engage with the pintle shaft 112 when the rotor 130 rotates around the pintle shaft 112. In other examples, the undercut sections 330 may be formed discontinuously around the pintle shaft 112 adjacent the mounting flange 118.

The present disclosure has been described in detail in the foregoing specification, and it is believed that various alterations and modifications of the many aspects of the present disclosure will become apparent to those ordinary skilled in the art from a reading and understanding of the specification.

What is claimed is:

1. A device comprising:
a housing having a hydraulic fluid inlet and a hydraulic fluid outlet;
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft coupled to the rotor and rotatably supported within the housing,
wherein the pintle shaft defines a fluid communication between the hydraulic fluid inlet and the plurality of cylinders and a fluid communication between the plurality of cylinders and the hydraulic fluid outlet; and
wherein the rotor is at least partially received within the housing and rotatably supported by the housing with a bearing.

2. The device of claim 1, wherein the rotor is partially supported on the housing adjacent to the hydraulic fluid inlet with the bearing.

3. The device of claim 1, wherein the hearing is a hydraulic journal bearing.

4. The device of claim 1, further comprising a flexible coupling for coupling the drive shaft with the rotor.

5. The device of claim 1, wherein the pintle has an inlet end and an outlet end, the inlet end adjacent to the hydraulic fluid inlet, and the outlet end opposite to the inlet end along a length of the pintle shaft, and wherein the pintle shaft includes a tapered portion arranged around the pintle shaft at the inlet end of the pintle.

6. The device of claim 5, wherein the tapered portion includes a first tapered portion and a second tapered portion, the first tapered portion arranged circumferentially around the pintle shaft adjacent the inlet end of the pintle, and the second tapered portion arranged circumferentially around the pintle shaft adjacent the outlet end of the pintle.

7. The device of claim 1, wherein the rotor and the drive shaft are integrally configured as one piece.

8. The device of claim 1, wherein the pintle shaft is at least partially supported by the drive shaft, and wherein the drive shaft is engaged at least partially with the pintle shaft and rotatable with respect to the pintle shaft.

9. The device of claim 1, wherein the drive shaft and the rotor is coupled by spline coupling.

10. The device of claim 1, wherein the pintle has an inlet end and an outlet end, the inlet end adjacent to the hydraulic fluid inlet, and the outlet end opposite to the inlet end along a pintle shaft axis, and
wherein the pintle shaft includes an undercut section around the pintle shaft adjacent the outlet end of the pintle.

11. A radial piston device comprising:
a housing having a hydraulic fluid inlet and a hydraulic fluid outlet;
a pintle attached to the housing, the pintle including a pintle shaft defining a pintle inlet and a pintle outlet, the pintle inlet being in fluid communication with the hydraulic fluid inlet, the pintle outlet being in fluid communication with the hydraulic fluid outlet;
a rotor mounted on the pintle shaft, the rotor being configured to rotate relative to the pintle about a rotor axis of rotation that extends through a length of the pintle shaft, the rotor defining a plurality of radially oriented cylinders and a plurality of rotor fluid ports;
a plurality of pistons, each being displaceable in each of the plurality of radially oriented cylinders, wherein the plurality of rotor fluid ports are in fluid communication with the plurality of radially oriented cylinders, and wherein the plurality of rotor fluid ports are alternately in fluid communication with either the pintle inlet or the pintle outlet as the rotor rotates relative to the pintle about the axis of rotation;
a thrust ring disposed about the rotor, wherein the thrust ring is in contact with each of the plurality of pistons, and wherein the thrust ring has a thrust ring axis that is radially offset front the rotor axis of rotation so that the plurality of pistons reciprocate radially within the rotor as the rotor rotates about the rotor axis of rotation; and
a drive shaft being coupled to the rotor and rotatably supported within the housing,
wherein the rotor is supported radially on the pintle shaft with a first bearing, and
wherein the rotor is at least partially received within the housing and rotatably supported by the housing with a second bearing.

12. The radial piston device of claim 11, wherein the housing includes a driving shaft housing and a rotor housing, the drive shaft housing having the hydraulic fluid inlet and the rotor housing having the hydraulic fluid outlet,
wherein the pintle attached to the rotor housing;
wherein the drive shaft rotatably supported within the drive shaft housing; and
wherein the rotor is at least partially received within the rotor housing and rotatably supported by the rotor housing with the second bearing.

13. The radial piston device of claim 11, wherein the rotor is supported radially on the pintle shaft adjacent to the pintle outlet with the first bearing.

14. The radial piston device of claim 11, wherein first bearing is a first hydrodynamic journal bearing.

15. The radial piston device of claim 11, wherein the rotor is partial supported on drive shaft housing adjacent to the pintle inlet with the second bearing.

16. The radial piston device of claim 11, wherein the second bearing is a second hydrodynamic journal bearing.

17. The radial piston device of claim 11, further comprising a flexible coupling for coupling the drive shaft with the rotor.

18. The radial piston device of claim 17, wherein the flexible coupling defines a flexible coupling flow passage in fluidic communication with the hydraulic fluid inlet and the pintle inlet.

19. The radial piston device of claim 17, wherein the rotor has an inlet end and an outlet end, the outlet end being opposite to the inlet end along the rotor axis of rotation, the inlet end coupled to the drive shaft with the flexible coupling therebetween.

20. The radial piston device of claim 19, wherein the rotor is partially supported on the drive shaft housing at the inlet end of the rotor with the second bearing.

21. The radial piston device of claim 19, wherein the rotor is supported radially on the pintle shaft at the outlet end of the rotor with the first bearing.

22. The radial piston device of claim 11, wherein the radial piston device is used as a pump in which torque is input to the drive shaft to rotate the rotor.

23. The radial piston device of claim 11, wherein the radial piston device is used as a motor in which torque from the rotor is output through the drive shaft.

24. The radial piston device of claim 22, wherein the plurality of radially oriented cylinders comprises a first cylinder set, and wherein the plurality of rotor fluid ports comprises a first rotor fluid port that is in fluidic communication with the first cylinder set,
wherein when the rotor is in a first position, the first rotor fluid port is in fluid communication with the pintle inlet, and wherein when the rotor is in a second position substantially opposite to the first position, the first rotor fluid port is in fluid communication with the pintle outlet,
wherein when the rotor is in the first position, fluid is drawn from the hydraulic fluid inlet into the first rotor fluid port via the pintle inlet and is drawn radially outward into the first cylinder set, and
wherein when the rotor is in the second position, the fluid is forced from the first cylinder set and the first rotor fluid port into the hydraulic fluid outlet via the pintle outlet.

25. The radial piston device of claim 21, wherein the pintle includes a mounting flange located at one end of the pintle shaft, and wherein the mounting flange is attached to the rotor housing via fasteners.

26. The radial piston device of claim 11, wherein the pintle has an inlet end and an outlet end, the outlet end opposite to the inlet end along a length of the pintle shaft, and wherein the pintle shaft includes a tapered portion arranged around the pintle shaft at the inlet end of the pintle.

27. The radial piston device of claim 26, wherein the tapered portion of the pintle shaft is configured and arranged to compensate a deflection of the pintle, shaft, thereby allowing the rotor to rotate around the deflected pintle shaft.

28. The radial piston device of claim 26, wherein the tapered portion includes a first tapered portion and a second tapered portion, the first tapered portion arranged circumferentially around the pintle shaft adjacent the inlet end of the pintle, and the second tapered portion arranged circumferentially around the pintle shaft adjacent the outlet end of the pintle.

29. The radial piston device of claim 26, wherein the tapered portion has a cone shape.

30. The radial piston device of claim 29, wherein the tapered portion is arranged circumferentially around the pintle shaft adjacent the inlet end of the pintle and configured to have an apex of the cone shape biased in a direction opposite to the inlet end of the pintle.

31. The radial piston device of claim 11, wherein the rotor and the drive shall are integrally configured as one piece.

32. The radial piston device of claim 11, wherein the pintle shaft is at least partially received and supported by the drive shaft, and wherein the drive shaft is engaged at least partially with the pintle shaft and rotatable with respect to the pintle shaft.

33. The radial piston device of claim 11, wherein the drive shaft has a driving end and a power transfer end, the power transfer end opposite to the driving end along a drive shaft axis of rotation,
wherein the drive shaft has a receiving portion formed at the power transfer end for at least partially receiving the pintle shaft therein, and
wherein the pintle shaft is partially supported in the receiving portion of the drive shaft at the power transfer end, and the receiving portion of the drive shaft is rotatably engaged at least partially with the pintle shaft at the power transfer end of the drive shaft.

34. The radial piston device of claim 32, further comprising a flexible coupling for coupling the drive shaft with the rotor.

35. The radial piston device of claim 11, wherein the drive shaft and the rotor is coupled by spline coupling.

36. The radial piston device of claim 11, wherein the drive shaft has a shaft head, a stem and a power transfer flange, the stem extending between the shaft head and the power transfer flange, the power transfer flange being coupled to the rotor by spline coupling.

37. The radial piston device of claim 36, wherein the power transfer flange has a coupling portion protruding therefrom, the coupling portion having a number of splines located on an outer surface thereof, and wherein the rotor has a number of corresponding splines located on an inner surface of the bore of the rotor at the inlet end, the splines of the coupling portion being engaged with the corresponding splines of the rotor.

38. The radial piston device of claim 11, wherein the pintle has an inlet end and an outlet end, the outlet end opposite to the inlet end along a pintle shaft axis,
wherein the pintle includes a mounting flange located at the outlet end of the pintle and attached to the rotor housing, and
wherein the pintle shaft includes an undercut section around the pintle shaft adjacent the mounting flange.

39. A radial piston device comprising:
a housing having a hydraulic fluid inlet and a hydraulic fluid outlet;
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft coupled to the rotor and rotatably supported within the housing,
wherein the pintle shaft defines a fluid communication between the hydraulic fluid inlet and the plurality of cylinders and a fluid communication between the plurality of cylinders and the hydraulic fluid outlet,
wherein the pintle has an inlet end and an outlet end, the inlet end adjacent to the hydraulic fluid inlet, and the outlet end opposite to the inlet end along a length of the pintle, shaft, and
wherein the pintle shaft includes a tapered portion arranged around the pintle shaft at the inlet end of the pintle.

40. The radial piston device of claim 39, wherein the tapered portion includes a first tapered portion and a second tapered portion, the first tapered portion arranged circumferentially around the pintle shaft adjacent the inlet end of the pintle, and the second tapered portion arranged circumferentially around the pintle shaft adjacent the outlet end of the pintle.

41. A radial piston device comprising:
a housing having a hydraulic fluid inlet and a hydraulic fluid outlet;
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft configured integrally with the rotor as one piece and rotatably supported within the housing,
wherein the pintle shaft defines a fluid communication between the hydraulic fluid inlet and the plurality of cylinders and a fluid communication between the plurality of cylinders and the hydraulic fluid outlet.

42. A radial piston device comprising:
a housing having a hydraulic fluid inlet and a hydraulic fluid outlet;
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft coupled to the rotor and rotatably supported within the housing,
wherein the pintle shaft defines a fluid communication between the hydraulic fluid inlet and the plurality of cylinders and a fluid communication between the plurality of cylinders and the hydraulic fluid outlet,
wherein the pintle shaft is at least partially received and supported by the drive shaft, and
wherein the drive draft is engaged at least partially with the pintle s a and rotatable with respect to the pintle shaft.

43. The radial piston device of claim 42, wherein the drive shaft has a driving end and a power transfer end, the power transfer end opposite to the driving end along a drive shaft axis of rotation,
wherein the drive shaft has a receiving portion formed at the power transfer end for at least partially receiving the pintle shaft therein, and
wherein the pintle shaft is partially supported in the receiving portion of the drive shaft at the power transfer end, and the receiving portion of the drive shall is rotatably engaged at least partially with the pintle shaft at the power transfer end of the drive shaft.

44. A radial piston device comprising:
a housing having a hydraulic fluid inlet and a hydraulic fluid outlet;
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft coupled to the rotor and rotatably supported within the housing,
wherein the pintle shaft defines a fluid communication between the hydraulic fluid inlet and the plurality of cylinders and a fluid communication between the plurality of cylinders and the hydraulic fluid outlet, and
wherein the drive shaft and the rotor is coupled by spline coupling.

45. The device of claim 44, wherein the power transfer flange has a coupling portion protruding therefrom, the coupling portion having a number of splines located on an outer surface thereof, and wherein the rotor has a number of corresponding splines located on an inner surface of the bore of the rotor at the inlet end, the splines of the coupling portion being engaged with the corresponding splines of the rotor.

46. A radial piston device comprising:
a housing having a hydraulic fluid inlet and a hydraulic fluid outlet:
a pintle attached to the housing and having a pintle shaft;
a rotor rotatably mounted on the pintle shaft and having a plurality of cylinders;
a plurality of pistons, each being displaceable in each of the plurality of cylinders; and
a drive shaft coupled to the rotor and rotatably supported within the housing,
wherein the pintle shaft defines a fluid communication between the hydraulic fluid inlet and the plurality of cylinders and a fluid communication between the plurality of cylinders and the hydraulic fluid outlet,
wherein the pintle has an inlet end and an outlet end, the inlet end adjacent to the hydraulic fluid inlet, and the outlet end opposite to the inlet end along a pintle shaft axis, and
wherein the pintle shaft includes a pre-defined flex location around the pintle shaft adjacent the outlet end of the pintle.

47. A device comprising:
a housing having a hydraulic fluid inlet and a hydraulic fluid outlet;
a pintle attached to the housing and having a pintle shaft, the pintle shaft having a base end and a free end opposite to the base end along a length of the pintle shaft, wherein the base end is fixed with respect to the housing;
a rotor rotatably mounted on the pintle shaft and having a plurality of cylinders, the rotor at least partially received within the housing adjacent the free end of the pintle shaft;
a plurality of pistons, each being displaceable in each of the plurality of cylinders;
a drive shaft rotatably supported within the housing;
a flexible coupling configured to couple the drive shaft and the rotor;
a first bearing positioned between the housing and the rotor adjacent the free end of the pintle shaft to rotatably support the rotor against the housing; and
a second bearing positioned between the pintle shaft and the rotor and located no more than half of the length of the pintle shaft from the base end of the pintle shaft, wherein no bearing is provided between the pintle shaft and the rotor at the remaining half of the length of the pintle shaft;
wherein the pintle shaft defines a fluid communication between the hydraulic fluid inlet and the plurality of cylinders and a fluid communication between the plurality of cylinders and the hydraulic fluid outlet.

48. The device of claim 47, wherein the second bearing is positioned between the pintle shaft and the rotor at a position spaced no more than ¼ of the length of the pintle shaft from the base end of the pintle shaft, and wherein no bearing is provided between the rotor and the pintle shaft at the remaining ¾ of the length of the pintle shaft.

49. The device of claim 47, wherein the second hearing is positioned between the pintle shaft and the rotor at a position spaced no more than ⅓ of the length of the pintle shaft from the base end of the pintle shaft, and wherein no bearing is provided between the rotor and the pintle shaft at the remaining ⅔ of the length of the pintle shaft.
